(19) United States
(12) Patent Application Publication
(10) Pub. No.: US 2022/0190634 A1
(43) Pub. Date: Jun. 16, 2022

(54) PLUG AND PLAY ENERGY STORAGE SYSTEM (PESS)

(71) Applicant: John Russell Ewart, La Mesa, CA (US)

(72) Inventor: John Russell Ewart, La Mesa, CA (US)

(21) Appl. No.: 17/547,451

(22) Filed: Dec. 10, 2021

Related U.S. Application Data
(60) Provisional application No. 63/124,285, filed on Dec. 11, 2020.

(51) Int. Cl. H02J 9/06; H02J 7/02; H02M 7/68

(52) U.S. Cl. CPC H02J 9/06; H02J 2207/20; H02M 7/68; H02J 7/02

(57) ABSTRACT

A plug and play energy storage system is described.

### RELATED APPLICATIONS

This application claims priority to the provisional patent application filed on Dec. 11, 2020, and assigned patent app. No. 63/124,285.

### BACKGROUND

The present application relates to a plug and play energy storage system.

### BRIEF DESCRIPTION OF THE DRAWINGS

FIGS. 1-10 show various examples of a plug and play energy storage storage.

### DETAILED DESCRIPTION

The plug and play energy storage system (pESS) is easy: being a true all-in-one plug-n-play system, just plug it in to any standard power outlet, without requiring professional installation, and without requiring a third party meter, circuits, monitoring, and so on. The system is affordable, being lower in cost and providing energy cost savings, and is also modular. The system is portable, and can be moved with a user, and taken on trips, camping, tailgating, to the park, to the beach, and so on. The system is safe, monitoring and controlling the flow of electricity (in/out) to keep users, their homes and devices, and utility workers safe. The system can further be implemented to have a fire-retardant battery fill pack and case, and include a fire and explosion proof battery cell.

The energy storage system time-shifts energy use and enables users to better use of renewable energy and avoids peak charge from the power company. It automatically stores energy at off-peak hours and powers a user's home at peak hours, which bridges the gap between the production of energy and peak demand. It also fortifies your home against power outages by providing a backup energy supply.

The energy storage system plugs into a standard power outlet via a power cord and standard power outlet. Power is collected to charge the batteries in the system, and power is distributed out to power all devices and appliances on the electrical circuit. An energy management system monitors and controls the flow of power in and out of the pESS to the customer settings for maximum efficiency, cost savings, and power availability. The system monitors power from the power company, and has the ability to shut down for safety. The system is a true plug and play device. There is no professional installation required, and no requirements to communicate with the power company electric meter or the home/building circuit breaker.

The system is also distributed and modular so a user can add multiple units to provide as much power as desired based on the size of the home and power usage. A user may add units as needed now or later as demand changes, so the user only purchases what he or she needs when needed. Multiple units can be distributed on multiple circuits (e.g., the average US home has two circuits). The system can be used in any size house, apartment, small office, etc. Additionally, the system is portable and can be used indoors or outdoors. A user's home can be powered 24/7 and when power is needed can be taken with the user: on trips, a day at the park or beach, camping, etc. Unlike noisy generators the system makes no noise. Furthermore, when a user moves he or she can take it along in comparison to an installed system that stays with the home.

A conventional energy storage system has a simple electricity flow. Electricity flows in one end from a power source and flows out the other end to power the home. This is why a conventional system requires professional installation, because it is physically and/or communicatively connected to the home circuit breaker panel. The circuit panel manages all the electricity flow in the home and to the main meter. A conventional system is not bidirectional.

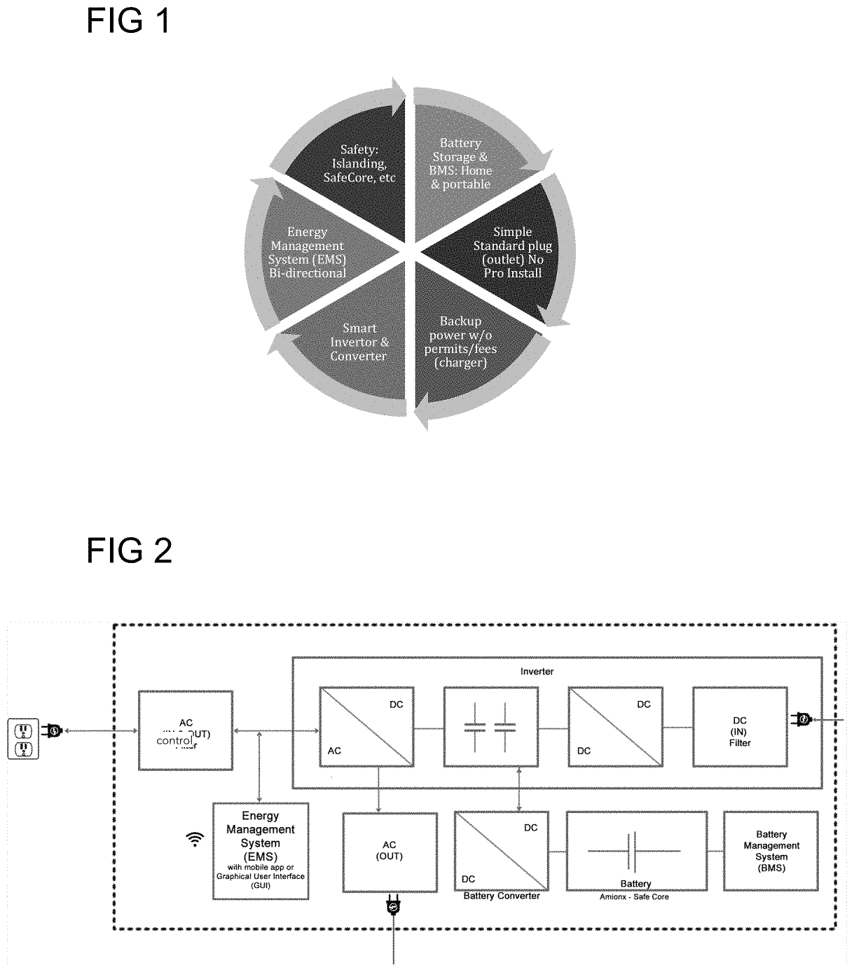

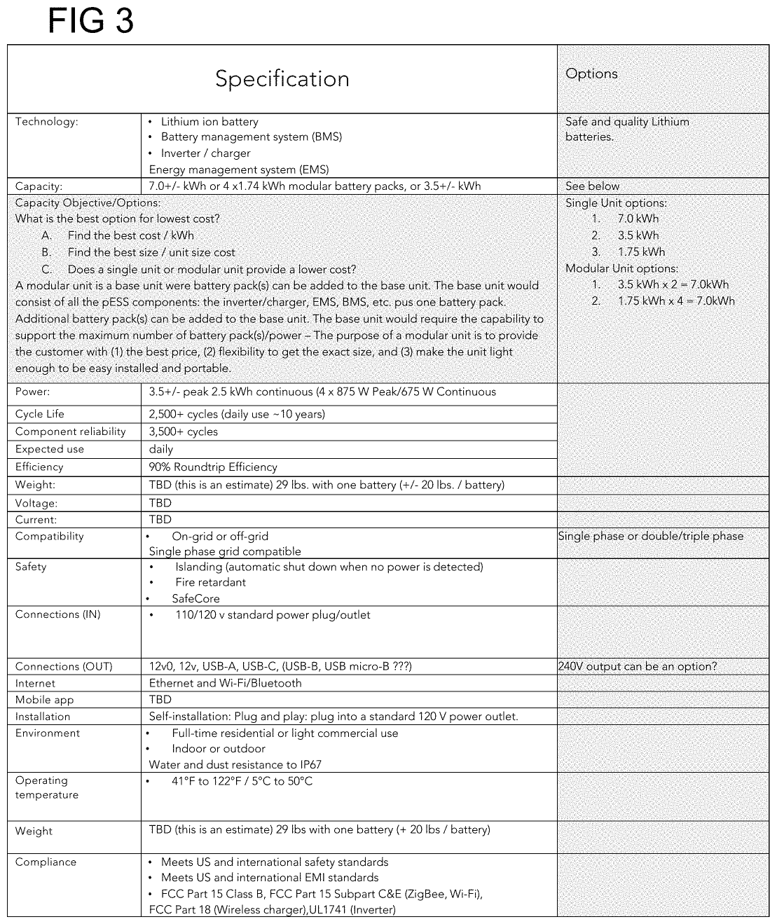

Referring to FIG. 1, by comparison, the inventive energy storage system is a battery storage system that plugs into a standard power (110/120v US) outlet. The storage system is intended for residential or small business use. The system can both store and distribute power as needed to the home through a standard power cord plugged into a standard power (110/120v US) outlet. The system will collect and store electric power through the power outlet from power produced by the power company when the electric rates are low or by the user's clean power (solar panels) during the daytime when it is free.

The system can provide electric power to the home daily as schedule based on the user's power source that is the power company or an alternative power source (i.e., solar/wind). The user can configure the system to charge itself when the solar panels are producing power or if the user does not have solar then when the electricity is at the cheapest rate.

The system provides power out to the home via the power outlet or to any appliances/devices that are plugged directly into the system. The system can be set for maximum cost savings or to store power in case of power outage, or in combination.

Unlike a battery backup generator that is only used during a power outage the system provides power daily, lowering or eliminating the need for electricity from the power company. During a power outage all appliances and devices that are plugged directly into the system will continue to be powered. For extremely long power outages (multiple days) the system is portable so can be transported for charging.

The system is designed to be modular and flexible so multiple systems can be distributed within a home to meet the desired power production and to provide power to important appliances and devices. For example, if an individual system produces 3 kW of power an average home may require 2 to 4 units.

Because homes in the United States have two separate circuits and most likely a homeowner would want to have a minimum of two systems to have alternative power storage available on both circuits providing the home with complete power coverage. The homeowner may desire more than two units if they have a large home or use a lot of power.

The energy storage system works as follows. The system produces electricity at a slightly higher voltage (5 volts +/−) then electricity provided by the power company. This allows electricity produced by the system to be differentiated for electrical flow direction, monitoring and safety purposes. The system power produced at a higher voltage will have priority over electricity from the power company at a slightly lower voltage, so the system can provide power or get charged as desired. The system has an energy management system (EMS) that manages the electricity flow (in/out, on/off), monitors and manages all controls and peripherals, provides many of the features and collects user data, and manages all the communications within the system.

The EMS provides, monitors, and manages the following primary functions. First, the EMS measures, monitors, and controls the flow of electricity in and out of the system and to the home. The system produces electricity at a slightly higher voltage (5 volts +/−) then electricity produced and provided by the power company so the EMS can distinguish the different power sources. In addition to controlling the power flow in and out of the system, the EMS also the brains of the system and communicates to all the internal systems.

Second, during normal power operations, power in is via the power cord, and power out is via the power cord. Power in can also be via the connection on the system (i.e., solar panels plugged in directly). Power out can also be via the connection on the system to devices plugged in directly to the system (i.e., any 110/120v devise or appliance can be plugged directly into the unit). USB and wireless charging can also be provided for smartphone, tablets, etc.

Third, during a power outage, the system will sense there is no power coming from the power company and the EMS will shut off power from the system into the electrical outlet/home. This is an important safety feature, to protect line workers that may be working on the powerlines outside the home. This also protects the users, so they do not get shocked when the system is unplugged (regardless of whether there is a power outage). That is, when no power is detected the power is shut off to the power out main power cord.

The system also has the capability to have devices plugged directly into it, so these devices will always be able to draw power from the system's battery regardless if there is a power outage. This provides battery backup to all the devices that are plugged directly into the system. This is another reason for the separate units in distributed modular design, so users can place systems where they have critical electric equipment, such as refrigerators, freezers, microwaves, computers, baby monitors, gaming devices, and other critical devices the homeowner wants to use during an outage or prevent damage during an abrupt outage.

Referring to FIG. 2, the major components of the energy storage system are shown. The EMS works as has been described above. The smart inverter can be bidirectional or require two different inverter/converters. The smart inverter is used to control and invert DC to AC power to power the home. It can also convert power from AC to DC to charge the battery. The smart inverter (i.e., grid-tied inverter) will measure and monitor the current in the power circuit and provide power out at a slightly higher phase voltage (i.e., +5 V) but still stay within the safety range for maximum voltage (i.e., a voltage range of 106V to 127V).

The smart inverter and EMS together provide the following capabilities and safety features. First, the smart inverter is able to push out power at a higher voltage so it will take priority over the power from the grid (power company). This allows the system to power the home and appliances at the desired times. Second, the same monitoring capability is used to shut down power flow out to the grid during a power outage. The EMS and smart inverter continually samples and monitors the grid power levels. Third, this feature also prevents power from going out of the power cord when it is unplugged and potentially shocking the user when unplugged and charged.

The battery can be a lithium-ion battery, or any rechargeable battery. The battery can be highly rated for number of recharges, and having a long battery life.

The battery management system (BMS) manages the battery cells for power flow, efficiency, and safety. It also monitors the total energy capacity and communicates to the system. The BMS monitors cell voltage and temperature; estimates state-of-charge and state-of-health; limits power input and output for thermal and overcharge protection; controls the charging profile; balances the state-of-charge of individual cells; and isolates the battery pack from the load when necessary.

The smartphone application (app) permits the user to control the energy storage system. The app provides for control of the operating modes for maximum cost savings or the desired power reserves. The app monitors and tracks power production, usage, and cost savings.

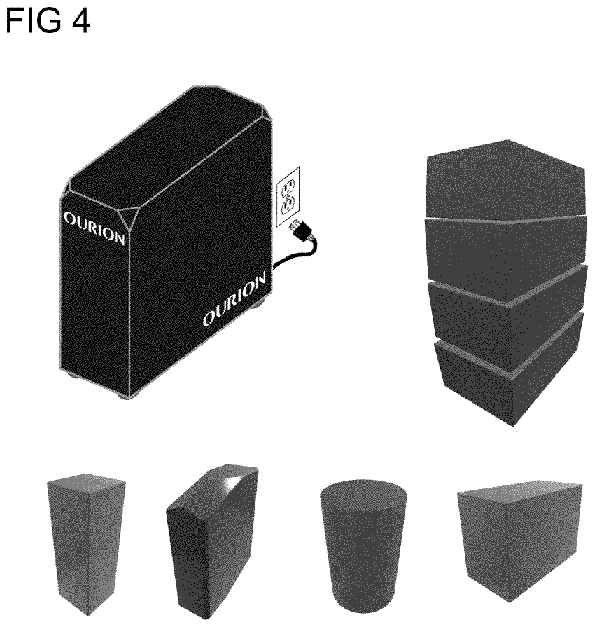

Referring to FIG. 4, several design and form factors of the energy storage system are shown. The system in one implementation can be free standing on the floor, having a size and weight so that it is portable, a shape so that it is convenient to carry and easy to conceal, and have an enclosure permitting it to be free standing on the floor and be used indoors and outdoors. The system can be internally cooled and vented, and may be placed in poorly vented locations such as behind a refrigerator, couch, desk/furniture, etc. The system may have optional wireless charging on top. The system may be modular or stackable, and/or may have a shape other than rectangular.

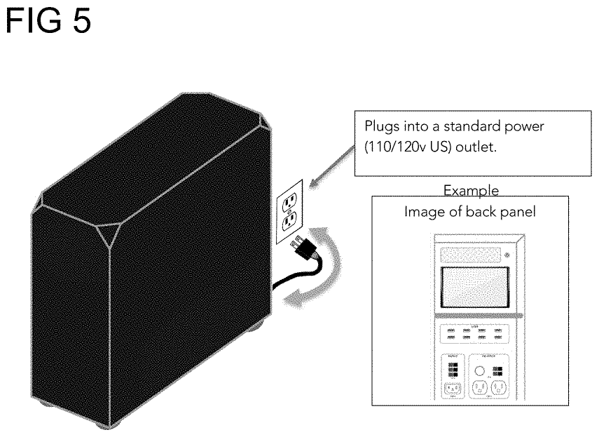

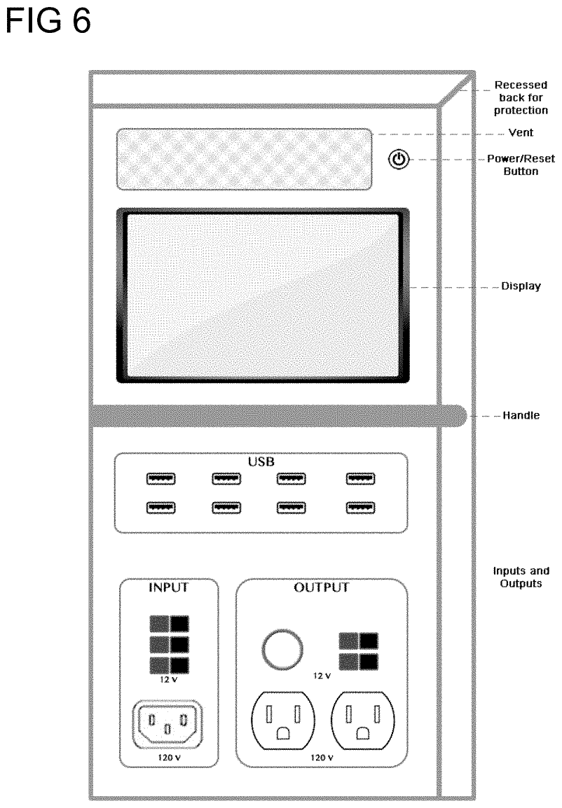

Referring to FIGS. 5 and 6, a high level bidirectional electrical flow of the energy storage system and an example back panel of the energy storage system are respectively shown. Electrical power flows in both directions. Inwards, electrical power flows in from the local power circuit of home grid. This is used to charge the battery. Outwards, electrical power flows out through the power outlet to provide power to all the devices on the circuit, or to any device that is plugged into the energy storage system per the back panel.

More specifically, power flows into the energy storage system via the power outlet and the power cord. The EMS manages and monitors the power flow. The converter converts AC to DC. The battery is charged and the BMS monitor the battery pack and individual cells for safety.

Also more specifically, power flows outwards from the energy storage system via the power outlet and power cord, or to devices that are directly plugged in. The EMS manages and monitors the power flow. The inverter converts DC to AC. The battery is charged and the BMS monitor the battery pack and individual cell for safety.

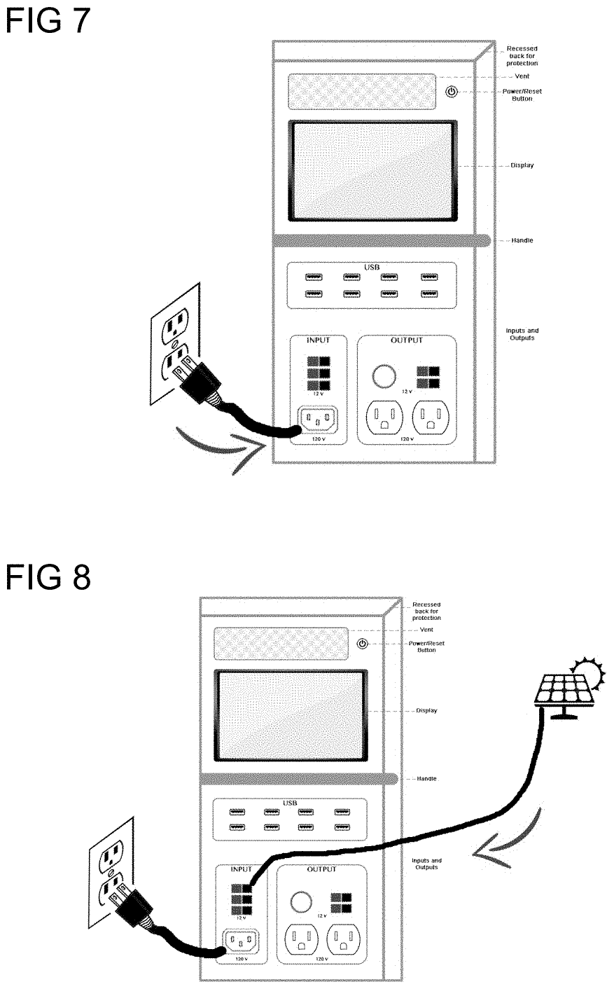

Referring to FIG. 7, inwards power flow is more specifically shown with respect to a user's power source, such as the power company, an alternative power source (i.e., solar, wind, etc.), solar or other alternative power source with a direct connection to the power company, or plug-n-play solar. For example, inwards power flow can be achieved via a power outlet, with the energy system plugged directly into the power outlet, in which case power flows inwards from the power outlet.

Referring to FIG. 8, inwards power flow in the case of a direct connected solar panel is shown. The solar panel or other alternative power source may be professionally installed, or a plug-n-play source directly connected to the energy storage system. No inverter is needed.

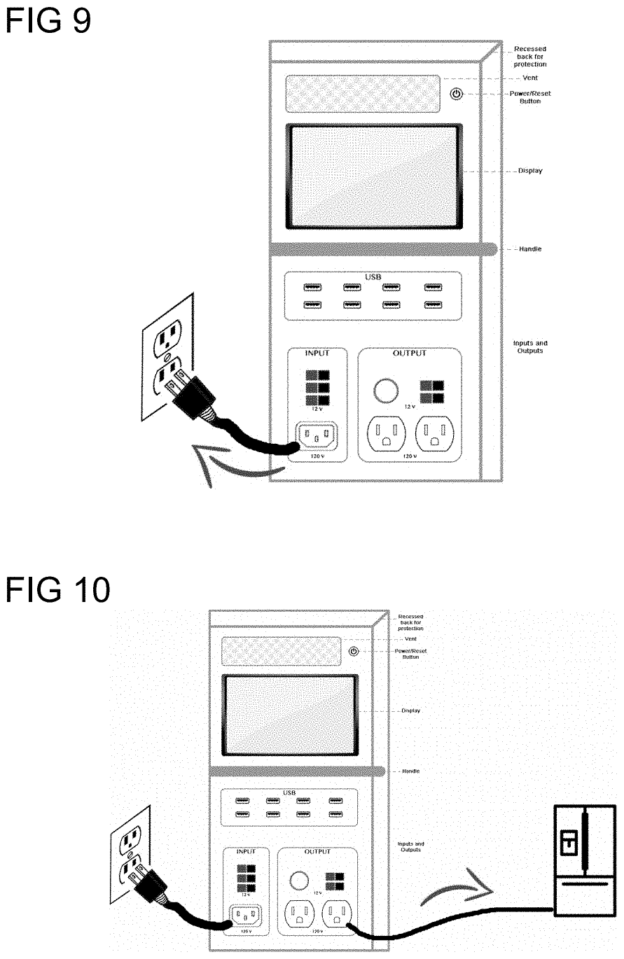

Referring to FIG. 9, outwards power flow is more specifically shown with respect to a power outlet, electrical power flows out through the power outlet to provide power to all the devices on the circuit in the home.

Referring to FIG. 10, outward power can thus be provided to any device or critical devices and appliances during a power outage. An appliance or other device can be plugged direct into the outputs on the energy storage system so that power can be directly provided to such devices.

The energy storage system can provide different operation modes, such as a cost savings mode and a power reserve mode. In the former, the user can set the energy storage system for a maximum cost-savings mode where the system will use all or most of its battery to provide power to the home. In the latter, the energy storage system will save a certain percentage of power for reserve in case there is a power outage or other need for reserve power. For example, the user can set the power reserve mode to not go below 25% (or any percentage) of available power.

What is claimed is:

1. A plug and play energy storage system.
